(19) United States
(12) Patent Application Publication
(10) Pub. No.: US 2024/0176935 A1
(43) Pub. Date: May 30, 2024

(54) METHOD FOR THE NUMERICAL SIMULATION OF UNSTRUCTURED DATA THROUGH MULTISCALE MACHINE LEARNING AND DETERMINISTIC SAMPLING

(71) Applicant: EXTRALITY, PARIS (FR)

(72) Inventors: Ahmed MAZARI, PARIS (FR); Thibaut MUNZER, PARIS (FR); Louis VERRET, Sèvres (FR); Pierre YSER, Savigny sur Orge (FR)

(21) Appl. No.: 18/549,488

(22) PCT Filed: Mar. 10, 2021
(86) PCT No.: PCT/FR2021/050408

§ 371 Date: Sep. 7, 2023

(51) Int. Cl. G06F 30/28; G06F 30/23; G06F 30/27; G06F 111/10; G06F 113/08

(52) U.S. Cl. CPC G06F 30/28; G06F 30/23; G06F 30/27; G06F 2111/10; G06F 2113/08

(57) ABSTRACT

A method for numerical simulation of a flow of a fluid in a space around a geometry, implemented by computer, including: a so-called deterministic sampling step, configured to process the initial mesh M₀ as an input so as to obtain a set of so-called simulation multiscale meshes, the set of simulation messages including a number Z≥1 of subsampled meshes Mᵢ; a step of generating a simulation result from at least one machine learning algorithm of the neural network type, previously trained from a database including a plurality of sets of so-called training multiscale meshes each associated with a numerical simulation, to provide a set of simulation data for all or some of the nodes of a mesh Mᵢ; in the set of multiscale meshes obtained during the deterministic sampling step.

### CROSS REFERENCE TO RELATED APPLICATIONS

This application is a National Stage of International Application No. PCT/FR2021/050408, having an International Filing Date of 10 March 2021, which designated the United States of America, and which International Application was published under PCT Article 21(2) as WO Publication No. 2022/189710 A1, the disclosure of which is incorporated herein by reference in its entirety.

### BACKGROUND

### Field

The field of the disclosure is that of numerical simulation.

More precisely, the disclosure relates to a method for multiscale numerical simulation on unstructured data by machine learning.

The disclosure in particular finds applications for simulating a complex physical phenomenon such as a flow of a fluid. This particular field of application is generally known by the English abbreviation CFD (standing for “Computational Fluid Dynamics”).

### Brief Description of Related Developments

Techniques of numerical simulation by automatic learning are known from the prior art, also known by the English term “machine learning”.

Among these techniques, there are numerous methods adapted for processing structured data, such as images for example. These images are naturally represented in the form of regular 2D or 3D grids. In particular, convolutional neural networks are known, abbreviated by the English acronym CNN (standing for “Convolutional Neural Network”), the objective of which is to process the input data by a cascade of convolutions separated by subsamplings, also known by the English term “pooling”, with a view to classification in the case of the processing of an image, for example.

Other techniques have been derived from this principle, adapted to more specific problems, such as image segmentation. Such a technique, known by the name “U-nets”, is in particular described in the article by Ronneberger et al. (2015) U-Net: Convolutional Networks for Biomedical Image Segmentation, Lecture Notes in Computer Science, vol 9351. The object of this technique is an architecture of the decoder-encoder type, consisting of several levels of encoding bricks processing by convolution and reducing a structured input data item, and of several levels of decoding bricks augmenting and processing by convolution the structured input data items. The particularity of this architecture is the aggregation, at each level, of the output data items of the encoding brick with the input data item of the decoding brick. This algorithmic structure is also known by the term “multiscale cascade”, in reference to the various reduction and augmentation scales of the data. In this way, the contextual information of the initial input data item (such as an image) is diffused through the encoding and decoding levels, making it possible ultimately to end up with a segmentation of the initial input data item.

In parallel, techniques for processing by machine learning for unstructured data are known. An unstructured data item is a data item that is not organized in a regular structure, as the pixels of an image would be for example. An unstructured data item is a data item that is not defined according to a particular format, such as for example a mesh. The unstructured data may in particular be represented by means of graphs, i.c. nodes connected by edges.

Machine learning techniques adapted to graphs have been developed, known in particular by the English abbreviation GNN (“Graph Neural Network”). Such techniques use neural networks for processing the information in each node, taking account of the states of the adjacent nodes on the structure of the graph, thus propagating the information on the graph.

The teaching of the “U-nets” architecture has been transposed to unstructured data in graph form in the context of the article by Gao and Ji (2019) Graph U-Nets, International Conference on Machine Learning (ICLR). The solution developed in the context of this work is known by the term “Graph U-nets”. In particular, this technique aims to learn an optimum sampling of the initial graph for encoding and decoding purposes. The advantage of this method is conferring the advantage of “U-nets” architecture on the processing of an unstructured data item, namely keeping the contextual information, i.e. relating to the configuration of the graph (in other words to the complex geometrical/topological data structure), through the levels of the encoder-decoder.

A physical mesh in two or three dimensions can be represented by a graph, each element of the mesh being able to be concentrated in a node of the graph. However, there does not generally exist any optimal graph for representing a mesh geometry, in particular in three dimensions. In addition, sampling, implemented in an optimized manner by a machine learning algorithm, in a non-deterministic manner, does not accord any importance to proximity between the nodes, thus not taking account of the physical reality that each subsampled graph represents.

The major drawback of the “Graph U-nets” technique is that it is unsuitable for certain types of unstructured data, and in particular for graphs representing physical geometries. Consequently, the prior art cannot be applied to problems involving physical geometries, such as for simulating flow of fluids in particular. There is therefore a need for allowing the numerical simulation of physical phenomena using machine learning algorithms on graphs, which the current techniques do not make it possible to implement.

There is also a need for reducing the computing time of methods for numerical simulation of complex physical phenomena, so as to be able to dispense with simulation techniques known in the CFD field.

There is also a need for reducing the energy consumption of a computer implementing a method for numerical simulation of complex physical phenomena.

Finally, there is also a need for making simulation methods more adaptable to the computing budget available for a user of said simulation method.

The present disclosure proposes to solve this problem by a completely innovative approach, aimed at making possible the numerical simulation of complex physical phenomena by machine learning while greatly reducing the computing time in comparison with the known techniques.

### SUMMARY

For this purpose, the disclosure relates to a method, implemented by computer, for numerical simulation of a flow of a fluid in a space around a geometry on which an initial M₀ mesh is defined, said initial mesh being divided into a number N of geometric elements, each geometric element being of the surface or volume type.

The method is in the form of a computer code that can be executed on an information processing system such as a computer.

A preliminary step of generating an initial M₀ mesh of said space is implemented before implementation of the simulation method, said initial mesh being divided into a number N of geometric elements, each element being of the surface or volume type.

This step corresponds to a normal meshing operation implemented upstream of a physical simulation. In particular, the elements are triangular or pyramidal elements, however any other type of element can also be envisaged. The number N of elements is fixed according to the performance of the computer available, but also according to the computing time that the user wishes to allow, among other things. For example, N is of the order of 10,000 to 1,000,000.

The method first of all comprises a so-called deterministic sampling step configured to process said initial mesh M₀ as an input so as to obtain a set of so-called simulation multiscale meshes, said set of simulation meshes comprising a number Z≥1 of subsampled meshes Mᵢ, i∈[1, . . . , Z], in accordance with the following criteria:
the subsampled mesh or meshes Mᵢ each include a number nᵢ of groups of geometric elements of said initial mesh, such that nᵢ being strictly less than N, each nᵢ being distinct;
each subsampled mesh Mᵢ being defined over the whole of said space;
the relationships between the groups of geometric elements of a subsampled mesh Mᵢ and of a subsampled mesh Mᵢ₊₁ being stored in an indexing table X_{i,i+1} ;
the number of subsampled meshes Mᵢ and the number nᵢ of groups of geometric elements of each subsampled mesh Mᵢ being predetermined parameters of said deterministic sampling step.

A subsampled mesh Mᵢ including a number nᵢ of groups of geometric elements of said initial mesh, such that nᵢ being strictly less than N, each nᵢ being distinct.

Thus the sampling step produces a number Z of subsampled meshes, which all include a number of groups of different geometric elements.

For example, it is sought to obtain, from an initial mesh including of the order of 10,000 elements, a subsampled mesh including of the order of 1000 groups of geometric elements, and another subsampled mesh including of the order of M₀ groups of geometric elements.

Each subsampled mesh Mᵢ is defined over the whole of said space.

Thus the space around the geometry is always entirely meshed by each subsampled mesh Mᵢ, the subsampling always being implemented over the whole of the domain in question. In particular, two different subsampled meshes Mᵢ do not coexist on the same space, i.e. the space is not partially meshed by two subsampled meshes. Mᵢ

The relationships between the groups of geometric elements of a subsampled mesh Mᵢ and of a subsampled mesh Mᵢ₊₁ are stored in an indexing table X_{i,i+1}.

In this way, passing from one subsampled mesh Mᵢ to another is always possible, the indexing table X_{i,i+1} being stored in a memory of the computer. Thus the result of the deterministic sampling step is stored and can also be reused subsequently in other simulations, but also for other subsampling or supersampling steps, in particular those implemented in the context of a subsequent machine learning algorithm.

The number of subsampled meshes Mᵢ and the number nᵢ of groups of geometric elements of each subsampled mesh Mᵢ are predetermined parameters of said deterministic sampling method.

In this way, the user can adapt the sampling step to their requirements, by controlling the sampling level.

The sampling step is said to be deterministic since it subsamples the initial mesh M₀ in a plurality of subsampled meshes Mᵢ in a determined and determinable manner. This is because the sampling is defined not only by criteria defined by the user such as:
the number of sampling scales or levels Z required: the user wishes for example to subsample the initial mesh, and then once again to subsample Z−1 times the result of the previous sampling;
the sampling step: the user wishes to define at which point the mesh is reduced between each subsampling,
   but also by predefined criteria according to which the sampling is implemented at each step, as will be explained below.

The method next comprises a step of generating a simulation result from at least one machine learning algorithm of the neural network type, previously trained from a database comprising a plurality of sets of so-called training multiscale meshes each associated with a numerical simulation, to provide a set of simulation data for all or some of the nodes of a mesh Mᵢ in the set of multiscale meshes obtained during the deterministic sampling step.

This step corresponds to the use of a machine learning algorithm, which may take the form of an algorithm known from the prior art. In particular, the initial mesh and the subsampled meshes being unstructured data that can be represented by graphs, the machine learning algorithm comprises at least one graph neural network (GNN), and more particularly a graph convolutional neural network (GCN). In such an algorithm, the characteristics in each node of the graph are processed by a conventional neural network, the input layer of which is connected to the node in question, as well as to the adjacent nodes on the graph. For the purposes of the simulation, these graph neural networks are trained, in accordance with known techniques, so as to provide a set of simulation data for the nodes of the output mesh or meshes (the output mesh—or graph—being able to correspond to the initial mesh, but may also be a subsampled mesh). This set of data can next be the subject of various representations, in a known manner, such as for example via a color-level representation of the values of a selected data item, which is generally a physical quantity such as a speed, a pressure, a force, etc.

The learning is implemented using a database comprising a plurality of sets of so-called training multiscale meshes each associated with a numerical simulation, these numerical simulations being obtained in advance by techniques known from the prior art.

Once the learning is implemented, the simulation method according to the disclosure supplies, from a meshed space, a set of simulation data for all or some of the nodes of a mesh Mᵢ in the set of multiscale meshes obtained during the deterministic sampling step. In particular, the mesh on which the result is given is a mesh according to the finest sampling.

According to a variant, each set of training multiscale meshes comprises a number Z of training meshes M_{1,e} to M_{Z,e} subsampled according to the sampling step from an initial training mesh M_{0,e}.

According to a variant, the set of simulation multiscale meshes also comprises the initial mesh M₀.

This configuration is particularly advantageous when the initial mesh is already sufficiently coarse to be able to be used by means of the simulation method, and thus makes it possible to reduce the number of sampling steps necessary.

According to a variant, the so-called deterministic sampling step comprises one of the following substeps:
a substep of defining a global group of geometric elements, forming a subsampled mesh M₁, said global group corresponding to all the geometric elements of the initial mesh M₀;
at least one substep of dividing a group of surface or volume elements, during which a group of surface or volume elements of a mesh Mᵢ, i∈[1, . . . , Z] comprising nᵢ groups of geometric elements is divided into a plurality of groups of geometric elements, so as to generate a subsampled mesh Mᵢ₊₁ comprising nᵢ₊₁ groups of geometric elements, with nᵢ₊₁>nᵢ.

By means of these provisions, the subsampling is obtained for each group of geometric elements by division. The division can be implemented in parallel for all the groups of geometric elements, so as to reduce the computing time.

It is specified that not all the groups of geometric elements are necessarily divided, some may remain undivided if this is not necessary for the requirements of the simulation.

According to a variant, the so-called deterministic sampling step comprises the following substeps:
a substep of defining an initial group, during which at least two surface or volume elements of the initial mesh M₀ are grouped in a group of geometric elements, so as to generate a subsampled mesh M_{Z};
at least one grouping substep, during which at least two groups of surface or volume elements of a subsampled mesh M₍ᵢ₊₁₎, i∈[0, . . . , Z−1] comprising n₍ᵢ₊₁₎ groups of geometric elements are grouped in a group of geometric elements so as to generate a subsampled mesh Mᵢ comprising nᵢ groups of geometric elements, with nᵢ <n₍₊₁₎.

By means of these provisions, the subsampling is obtained for each group of geometric elements by aggregation or grouping. The grouping can be implemented in parallel for all the groups of geometric elements, so as to reduce the computing time.

It is stated that, in this variant, not all the groups of geometric elements are necessary grouped together, some being able to remain distinct, so as to locally create zones meshed more or less densely.

According to a variant, the division substep comprises the following operations:
an operation of subdivision by two of a group of geometric elements of the subsampled mesh Mᵢ, so as to obtain two sets in said group of geometric elements; followed by
one or more operations of subdivision by two of at least one set obtained during a previous subdivision operation;
   the sets obtained at the end of the last operation of subdivision by two corresponding to groups of geometric elements of the subsampled mesh M₍ᵢ₊₁₎.

In this way, the division of the groups of geometric elements is implemented successively by deterministic division operations. It is thus possible to obtain a level of granularity of the sampling according to the requirements of the simulation or according to the hardware availabilities, by dividing by two a greater or lesser number of times. It is stated that only certain elements may be the subject of a division, and this according to different granularities.

According to a variant, in the operation of subdivision by two, the assigning to one or other of the sets is determined using a criterion of physical similarity between two geometric elements.

According to a variant, the criterion of physical similarity between two geometric elements is a criterion of spatial proximity in said space.

Thus the division is implemented so as always to obtain two groups or sets of geometric elements having the greatest similarity. The two sets obtained at each step therefore respect the geometry and physics of the mesh, in particular two elements too far away from each other cannot be in the same set. Physical coherence of the subsampling is thus guaranteed.

According to a variant, the indexing table X_{i,i+1} is a pair consisting of a subsampling matrix and of a supersampling vector, defining a bijective relationship between the groups of geometric elements of a subsampled mesh Mᵢ and those of a subsampled mesh Mᵢ₊₁.

In this way, passing from one subsampled mesh to another is possible. The bijective relationship is a relationship making it possible firstly to attribute to a group of elements of a “coarser” sampling the groups of elements of a “finer” sampling, and secondly to define the belonging of the groups of elements of a “finer” sampling to the groups of elements of a “coarser” group of elements.

The deterministic sampling step thus produces information making it possible to express the passage from one subsampled mesh to another, this passage being possible simply using the indexing table stored in a memory of the computer, and therefore constitutes a deterministic procedure the result of which can be determined without any problem.

According to a variant, the machine learning algorithm comprises a so-called encoding part and a so-called decoding part.

The so-called encoding part comprising a plurality of subparts for processing by a neural network operating in cascade, the information output from an upstream subpart GNNᵢ₊₁ being subsampled in order to form an input of a downstream subpart GNNᵢ.

The so-called decoding part comprising a plurality of subparts for processing by a neural network operating in cascade, the information output from a downstream subpart GNNᵢ being supersampled in order to form an input of an upstream subpart GNNᵢ₊₁.

Said subsamplings and said supersamplings between two successive subparts GNNᵢ and GNNᵢ₊₁ being determined by means of said indexing table X_{i,i+1}.

By means of these provisions, an architecture of the “U-net” type is obtained that is particularly advantageous for processing problems defined on unstructured data, such as graphs, and more particularly physical meshes.

Combining an architecture of the “U-net” type with the deterministic sampling step makes it possible to exploit the performance of the architecture while safeguarding physical coherence when the information is sampled, which is of prime importance in the context of a physical simulation.

In particular, the information on the context of the simulation, i.e. the link between the various geometric elements of the mesh, is preserved through the subsampling and supersampling steps necessary in this type of architecture.

Another object of the disclosure is a device comprising a processor and a computer storage memory, said memory comprising instructions for configuring the processor to implement the simulation method according to the disclosure.

### BRIEF DESCRIPTION OF THE FIGURES

Other advantages, aims and particular features of the present disclosure will appear from the following non-limiting description of at least one particular aspect of the devices and methods that are objects of the present disclosure, with reference to the appended drawings, wherein:

FIG. 1 is a mesh of a space or of a geometry according to one example;

FIG. 2 is a representation in the form of a graph of the mesh of FIG. 1;

FIG. 3 is a block diagram of an aspect of the simulation method according to the disclosure;

FIG. 4 is a block diagram of an aspect of the deterministic sampling step according to a first variant;

FIG. 5a is a group of global elements in the deterministic sampling step;

FIG. 5b is a sampled mesh of the global group of elements of FIG. 5a after a first division substep;

FIG. 5c is a sampled mesh of the global group of elements of FIG. 5a after a second division substep;

FIG. 6 is a block diagram of an aspect of the deterministic sampling step according to the disclosure according to a second variant.

### DETAILED DESCRIPTION

This description is given on a non-limiting basis, each feature of an aspect may advantageously be combined with any other feature of any other aspect.

It should be noted, as of now, that the figures are not to scale.

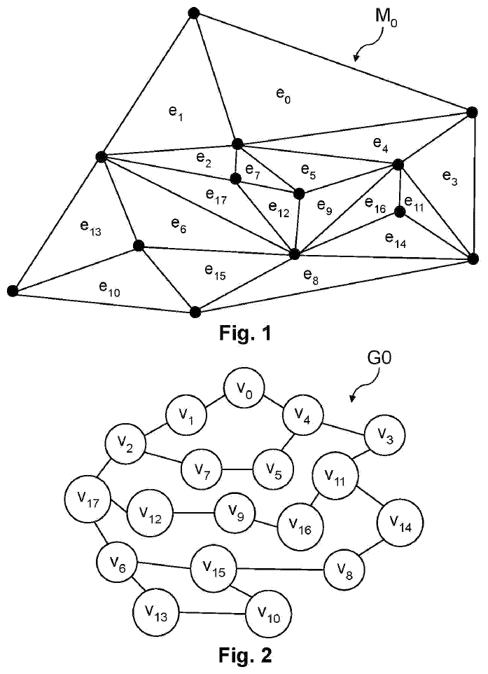

FIG. 1 shows a mesh M₀ of a physical topology, which may be a geometry or a space around a geometry, generated during a step of generating the initial mesh M₀ of said space or geometry. In the field of the simulation of flow of fluids, FIG. 1 can therefore represent either the mesh of an object immersed in a fluid, or the mesh of a volume of fluid. The mesh is defined in a reference frame, preferentially Cartesian, making it possible to assign position coordinates, i.e. spatial coordinates, to each element of the mesh.

In the non-limitative example of FIG. 1, the mesh M₀ comprises 18 geometric elements, here surface elements, referenced e₀ to e₁₇. However, it will be borne in mind that it is a case not only of a value given by way of example, since the disclosure can be generalized to meshes comprising a number N of elements. The number N of elements is not limited per se, although the computing power of the computer implementing the method that is the object of the disclosure represents an upper limit for the number of elements acceptable.

The mesh M₀ of FIG. 1 can be represented as a G0 graph, as shown in FIG. 2. Each element e₀ to e₁₇ of the mesh M₀ is represented by a node v₀ to v₁₇ of the G0 graph, the topology of the mesh M₀ being preserved. It has been supposed here that the mesh is two-dimensional, being thus more suitable for purposes of representation. A three-dimensional mesh, composed of volume geometric elements, can also be represented by at least one graph (this is because there is a plurality of graphs that can represent the same mesh).

The structure of a graph can be defined by an adjacency matrix A, expressing the presence of an edge between two nodes. In the case of a non-oriented graph, as is the case in the present disclosure, the adjacency matrix A is symmetrical.

In the example considered, the adjacency matrix is of dimension 17×17, so as to express the presence or not of connections between each node.

Each node includes information in the form of a vector of characteristics ψ, comprising in particular the coordinates of the center of the element corresponding to the node, the normals and the surfaces of the element, as well as the limit conditions of the element.

In this way, the physical information of the mesh is entirely represented by the corresponding graph.

In order to provide additional contextual information, a function k of similarity between two nodes is defined as follows:

$$k ( v , {v}^{′} ) = exp ( - \frac{{‖ ψ ( v ) - ψ ( {v}^{′} ) ‖}_{2}^{2}}{σ} ) \qquad [ Math . 1 ]$$

In the expression [Math. 1], σ is a normalization coefficient. The effect of the function k is to express the similarity between two nodes, from a point of view of the characteristics thereof, by a number between 0 and 1.

The information contained in the adjacency matrix A and in the similarity function k makes it possible, in combination, to express the physical configuration of the mesh underlying the graph.

As will be seen later, the adjacency table (as well as the similarity function) can be reduced or augmented depending on whether a subsampling or supersampling of the mesh/graph is implemented, while preserving the physical information of the mesh.

In order to improve the performance of the neural networks on graphs (GNN) described hereinafter, the adjacency matrix is normalized according to a known procedure.

In particular, the so-called “isotropic” graph neural networks are normalized so as to add an “edge” the points of departure and arrival of which are one and the same node. For more details, reference will be made to the article by Kipf et al. (2017) Semi-Supervised Classification with Graph Convolutional Networks, ICLR.

Hereinafter, the terms graph and mesh will be used equivalently, passing from one representation to another being possible at any time. Thus it is relevant to reason in terms of mesh in the context of a sampling step that will be described hereinafter, and in terms of a graph in the context of implementation in the machine learning algorithm making it possible to end up with the result of the simulation.

### Implementation in the Context of an Architecture of the “Graph U-Net” Type

In the numerical simulation method 500 according to the disclosure, the deterministic sampling step 400 according to the disclosure is independent of the machine learning algorithm that implements it. However, before beginning the deterministic sampling step 400 as such, a concrete example of implementation is given, in order better to understand the context of implementation of the disclosure.

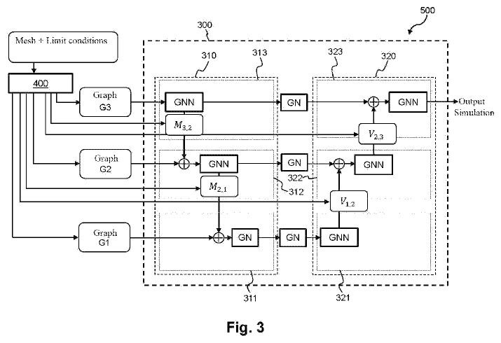

FIG. 3 is an outline diagram of the numerical simulation method 500 according to the disclosure, comprising a graph encoding-decoding method 300, according to one possible variant of the disclosure, and also implementing the deterministic sampling step 400 according to the disclosure. The method 300 takes an architecture of the “U-net” type in order to implement the deterministic sampling step 400 according to the disclosure, but other architectures can also be envisaged.

It is stated that the boxes with straight edges on FIG. 3 represent algorithmic steps or methods, the rounded boxes referring to intermediate results being exchanged between the algorithmic steps or methods, the arrows representing the exchange of these results, and of information.

As seen above, the encoding-decoding method 300, known from the prior art, is a machine learning algorithm type particularly adapted for processing unstructured data.

By way of example, the encoding-decoding method 300 comprises three encoding-decoding levels, although any other number of levels can be selected, according to the simulation requirements or the computing budget allocated.

The architecture of the encoding-decoding method 300 is not presented hereinafter except by way of reminder, and reference should be made to the literature of the prior art for more details.

As can be seen in FIG. 3, the encoding-decoding method 300 comprises an encoding part 310 comprising 3 encoding subparts 311, 312 and 313, and a decoding part 320 comprising 3 decoding subparts 321, 322, 323.

Each subpart 311, 312 and 313 of the encoding part 310 processes as an input each respectively the data of the nodes of the graphs G1, G2 and G3, as shown by an arrow on FIG. 3.

In particular, the encoding subpart 313 of the top level, referred to as “fine”, processes as an input the data of the nodes of a non-sampled graph G3 (or subsampled according to a finest scale). This graph G3 corresponds here to an initial mesh M₀ i.e. a mesh generated in a step of generating the initial mesh M₀ of the space. This initial mesh is divided into a number of geometric elements N, according to the example in FIG. 1 into 18 surface elements (but able to be volume elements according to another example).

The encoding subpart 312 of the following level, referred to as “intermediate”, and the encoding subpart 311 of the bottom level, referred to as “coarse”, process as an input respectively the data of the nodes of a graph G2 and G1. The graph G2 corresponds to the subsampling graph G3 according to the deterministic sampling step 400, which will be described hereinafter. The graph G1 corresponds to the subsampling graph G2 according to the deterministic sampling step 400, corresponding to the highest subsampling level in the present example.

The encoding subparts 312 of the intermediate level and 311 of the bottom level also process as an input respectively the output of the encoding subparts 313 of the top level and 312 of the intermediate level.

An output of an encoding subpart can be defined as an output graph comprising a number of nodes identical to the graph processed as an input, each node of the output graph including information augmented by the processing by a graph neural network (GNN), as mentioned below, the output finally being subsampled so as to be able to be processed by a bottom-level encoding subpart. This subsampling step is illustrated by the boxes bearing the mentions M_{3,2} and M_{2,1}. The subsampling is obtained using the result of the deterministic sampling step 400 according to the disclosure, as explained in more detail in the section “Subsampling and supersampling”.

More precisely, the characteristics, or data, of each node of the aforementioned output graphs are aggregated, node by node, with the characteristics, or data, of each node of the graphs G2 and G1, according to the level in question, as can be seen in FIG. 3. It is stated that the signs “+” on FIG. 3 represent the concatenations of characteristics of each node of the respective graphs but any other aggregation operation can be used (such as an addition, subtraction, multiplication, division).

In other words, the encoding subparts 312 of the intermediate level and 311 of the bottom level process augmented information, because account is taken of the result of the immediately higher finer encoding subpart. In this way, the information is propagated physically through the scales.

The encoding subparts 311, 312 and 313 and decoding subparts 321, 322 and 323 consist of one or more graph neural networks (GNN), in a manner known from the prior art.

The decoding subparts 321, 322, 323 of each encoding-decoding level implement a similar procedure, in which the output of each encoding subpart of the level in question is aggregated node by node at the output of each decoding subpart of the lower level, immediately lower (except in the case of the bottom level, as can be seen on FIG. 3). The output of a decoupling subpart of lower level is supersampled before being aggregated, so as to be able to be processed by a decoding subpart of higher level. This supersampling step is illustrated by the boxes bearing the mentions V_{1,2} and V_{2,3}. The supersampling is obtained using the result of the deterministic sampling step 400 according to the disclosure, as explained in more detail in the section “Subsampling and supersampling”.

It should be stated that the output of an encoding subpart of a level can be processed by one or more additional GNNs before being aggregated, in order to extract more characteristics, as can be seen by the arrows and the “GNN” boxes in broken lines between the parts 310 and 320. The operation of the decoding part is not repeated in detail here, and reference should be made to the literature of the prior art for the global operation of this type of architecture.

In summary, in the encoding-decoding method 300, each so-called encoding part comprises a plurality of subparts for processing by a neural network operating in cascade, corresponding here to the encoding subparts 311, 312 and 313, the information output from an upstream subpart GNNᵢ₊₁ being subsampled in order to form an input of a downstream subpart GNNᵢ.

Each so-called decoding part comprises a plurality of subparts for processing by a neural network operating in cascade, corresponding here to the decoding subparts 321, 322 and 323, the information output from a downstream subpart GNNᵢ being supersampled in order to form an input of an upstream subpart GNNᵢ₊₁.

Said subsamplings and said supersamplings between two successive subparts GNNᵢ and GNNᵢ₊₁ are determined by means of an indexing table X_{i,i+1}, as presented in the “Subsampling and supersampling” part.

The result of the encoding-decoding method 300, at the output of the decoding subpart 323, is a representation of the original graph G3, comprising information processed in each node, which can be used with techniques known from the prior art in order to solve the numerical simulation problem, after training of the graph neural networks (GNN).

Thus, in the course of a step of generating a simulation result using at least one machine learning algorithm such as the encoding-decoding method 300, previously trained from a database comprising a plurality of sets of so-called training multiscale meshes each associated with a numerical simulation, to provide a set of simulation data for all or some of the nodes of a mesh Mᵢ in the set of multiscale meshes obtained during the deterministic sampling step.

A set of training multiscale meshes comprises a number Z of training meshes M_{1,e} to M_{Z,e} subsampled according to the sampling step 400, from an initial training mesh M_{0,e}. In the present example, the training database comprises a given number j (for example one hundred) of sets of multiscale meshes M_{1,e,j} to M_{3,e,j}, obtained from training numerical simulations on initial training meshes M_{0,e,j}, and being obtained by means of the sampling method 400. In particular, regression methods can be applied to each node v, the result being associated with target values of quantities such as for example a shear force, an isostatic pressure, volume, or hydrodynamic forces. It is thus possible to obtain a representation of the initial mesh comprising information on the values of the aforementioned quantities, example by color-level representation, as is done usually in the context of numerical simulations.

### Sampling Step According to the Disclosure

First of all, it is stated that the deterministic sampling step 400 according to the disclosure is independent of the machine learning method 300 in which it is implemented.

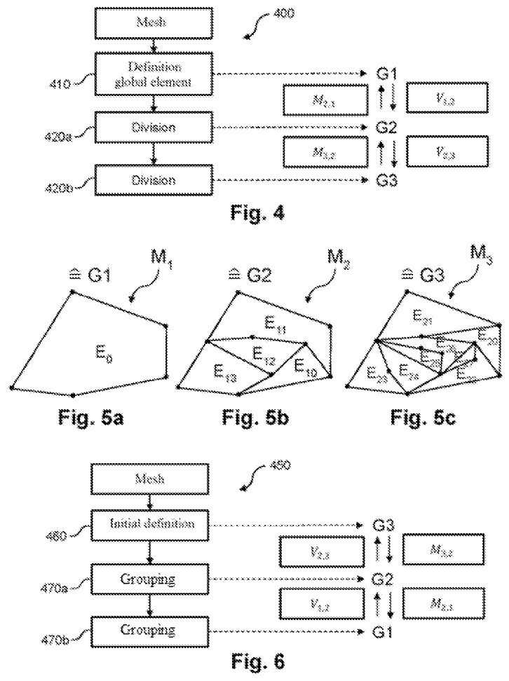

According to a first variant, the deterministic sampling step 400 shown in FIG. 4 comprises a first step 410 of defining a global group E, of geometric elements, corresponding to the set of all the elements of the initial mesh M₀, forming a subsampled mesh M₁.

FIG. 5a shows a subsampled mesh M₁ with a global group E₀ of geometric elements of the mesh M₀ of FIG. 1, corresponding to the 18 elements of the mesh M₀. Thus the subsampled mesh M₁ comprising n₁=1<N=18 groups of elements, the subsampled mesh M₁ being defined over the whole of the space.

In a substep 420 of dividing the group of geometric elements, the global element E₀ is split, or divided, so as to obtain a plurality of groups of geometric elements, said groups being smaller, i.e. including fewer elements, than the group from which they came. FIG. 5b illustrates by way of example a division of the elements in FIG. 5a into 4 groups of elements E₁₀ to E₁₃, obtained at the end of a first division substep 420a.

This first division substep 420a thus makes it possible to end up with a subsampled mesh M₂ comprising n₂=4<N=18 groups of elements, with n₂>n₁ and n₂≠n₁, the subsampled mesh M₂ being defined over the whole of the space.

The deterministic sampling substep 400 comprises at least one division substep 420, as illustrated above.

However, in general, the deterministic sampling substep 400 comprises a plurality of division substeps 420, concatenated one after another.

Continuing with the example in FIG. 5b, in a second division substep 420b, each group of elements obtained previously is divided into two new groups of elements, so as to obtain 8 groups of elements E₂₀ to E₂₇, as can be seen on FIG. 5c. Division by two is here selected by way of example, and it is entirely possible to divide once again by four, as in substep 420a, or by any other number greater than two.

This first division substep 420b thus makes it possible to end up with a subsampled mesh M₃ comprising n₃=8<N=18 groups of elements, with n₃>n₂ and n₃≠n₂≠n₁, the subsampled mesh M₃ being defined over the whole of the space.

In this example, the initial mesh M₀ comprising 18 elements is therefore subsampled in a plurality of subsampled meshes M₁, M₂ and M₃ comprising respectively 1, 4 and 8 groups of geometric elements. The granularity of the various sampling scales thus constructed can be selected freely, so as to adapt in particular to the physical constraints of the problem and to the computer equipment available to the user.

In this example, all the groups of geometric elements have been divided at each substep, it can however be envisaged not dividing certain groups of geometric elements during certain division substeps.

It is clear that these division substeps can be continued recurrently, at least one group of geometric elements of a mesh Mᵢ, comprising nᵢ groups of geometric elements, with i integer between 1 and Z, being divided into a plurality of groups of geometric elements, so as to generate a subsampled mesh Mᵢ₊₁ comprising nᵢ₊₁ groups of geometric elements, with nᵢ₊₁>nᵢ.

In summary, according to this first variant, the extreme points of the initial mesh serve to define a global element E₀, defining a mesh M₁ that is successively divided, at a pitch that can be adapted (for example here a pitch of division by 4, and then by 2, selected by the user), so as to obtain a plurality of meshes, and by extension graphs (the subsampled meshes M₁, M₂ and M₃ being able to be respectively represented by graphs G1, G2 and G3), representing various sampling scales.

In the light of FIGS. 5a to 5c, it will also be understood that passing from a fine mesh to a coarser mesh, i.e. from FIG. 5c to FIG. 5a, corresponds to a subsampling, and passing from a coarse mesh to a fine mesh, i.e. from FIG. 5a to FIG. 5c, corresponds to a subsampling, corresponds to a supersampling. It will also be understood that the three meshes in FIGS. 5a to 5c are all subsampled meshes of the initial mesh in FIG. 1, at different sampling levels.

According to a second variant, illustrated in FIG. 6, the deterministic sampling step is “reversed”, the subsampled meshes Mᵢ and obtained by successive groups from the initial mesh M₀.

More precisely, the sampling step 450 according to a second variant comprises a substep 460 of defining an initial group, during which at least two geometric elements of the initial mesh M₀ are grouped in a group of geometric elements, so as to generate a subsampled mesh M_{Z}, corresponding here to the mesh M₃ in FIG. 5c. In this example, 18 geometric elements are assembled in 8 groups of geometric elements. Thus it is clear that the groups, during this initial definition substep, can be made in pairs for certain geometric elements, and in triplets for others, for example.

This definition substep 460 is followed by two grouping substeps 470a and 470b, in the present example, during which at least two groups of geometric elements of a subsampled mesh Mᵢ₊₁ comprising nᵢ₊₁ groups of geometric elements, with i integer between 1 and Z−1, are grouped in a group of geometric elements so as to generate a subsampled mesh Mᵢ comprising nᵢ groups of geometric elements, with nᵢ<nᵢ₊₁.

In the example in question, during a first grouping substep 470a, the n₃=8 groups of geometric elements are grouped by pairs so as to obtain n₂=4 groups of geometric elements including more geometric elements, with n₂<n₃.

During a second grouping substep 470b, the n₂=4 groups of geometric elements are grouped by fours so as to obtain n₁=1 groups of geometric elements including more geometric elements, with n₁<n₂.

It is thus clear that it is possible to obtain the same subsampled meshes M₁, M₂ and M₃ by a grouping, or aggregation, approach in a way that is completely equivalent to the first variants presented.

### Division Step

In particular, the division substep 420 of the sampling step 400 according to the first variant comprises at least one operation of subdivision by two of a group of geometric elements.

Such an operation is also known by the term “descending hierarchical clustering”.

Such approaches are known in the prior art, and reference will be made in particular to the approach described in the article by Szekely et al. (2005), Hierarchical Clustering via Joint Between-Within Distances: Extending Ward's Minimum Variance Method. This technique has been successfully implemented in the context of the present disclosure, and has the technical advantage of being able to be implemented in parallel for each divided group of geometric elements, so as to reduce computing time, as well as energy consumption.

The division substep 420 comprises an operation of subdivision by two of a group of geometric elements of a subsampled mesh Mᵢ, so as to obtain two sets in said group of geometric elements.

This operation of subdivision by two of a group of geometric elements is followed by one or more operations of subdivision by two of at least one set obtained during a previous subdivision operation.

The sets obtained at the end of the last operation of subdivision by two correspond to groups of geometric elements of the subsampled mesh Mᵢ₊₁.

Taking the example of the division step 420a making it possible to pass from the mesh M₁ to the mesh M₂, a first operation of subdivision by two makes it possible to pass from one group of elements to two groups of elements, and a second operation of subdivision by two makes it possible to pass from two sets to four sets, corresponding to the groups of elements E₁₀ to E₁₃ of the mesh M₂.

In other words, the granularity level of each sampling step can be adjusted by executing in cascade simple steps of subdivision by two.

With regard to the criterion for subdivision by two, i.e. determining whether a geometric element belongs to one or other of the sets during each operation of subdivision by two, this criterion is selected so as to respect the physical coherence of the mesh.

More precisely, the assigning to one or other of the sets is determined using a criterion of physical similarity between two geometric elements, this criterion corresponding in particular to the spatial proximity in the space of two geometric elements.

However, a more complex criterion, corresponding for example to the function k of similarity between two geometric elements, can be used. In this way, it is ensured that only the most similar geometric elements are assigned to one or other of the sets.

This criterion being defined in a completely deterministic manner, from physical parameters of the mesh, the operation of subdivision by two participates in the deterministic character of the deterministic sampling step, each subsampling being determinable and determined using physical criteria.

### Subsampling and Supersampling

The relationships between the groups of geometric elements of a subsampled mesh Mᵢ and of a subsampled mesh Mᵢ₊₁ (or of corresponding graphs) obtained during the deterministic sampling step 400 are stored in an indexing table X_{i,i+1}.

More precisely, the indexing table X_{i,i+1} is a pair comprising a supersampling vector, for passing from a coarse scale to a fine scale, and a subsampling matrix, for passing from a fine scale to a coarse scale, as mentioned above.

In the example implementation in FIG. 3, the indexing table X_{2,3} making it possible to pass from a mesh M₃ to a mesh M₂ and vice versa (or from a graph G3 to a graph G2 and vice versa) comprises a subsampling matrix M_{3,2} that makes it possible in particular to subsample the result coming from the encoding subpart 311, a supersampling vector V_{2,3} that makes it possible in particular to supersample the result coming from the decoding subpart 322.

The indexing table X_{1,2} making it possible to pass from a mesh M₂ to a mesh M₁ and vice versa (or from a graph G2 to a graph G1 and vice versa) comprises a subsampling matrix M_{2,1} that makes it possible in particular to subsample the result coming from the encoding subpart 321, a supersampling vector V_{1,2} that makes it possible in particular to supersample the result coming from the decoding subpart 332.

In other words, the subsampling matrices and the supersampling vectors make it possible to effect a transfer of information, node to node, between the various scales, i.e. the indexing table X_{i,i+1} defines a bijective (or bijective-bijective, the application being bidirectional) relationship between the groups of geometric elements of a subsampled mesh Mᵢ and the groups of geometric elements of a subsampled mesh Mᵢ₊₁.

### Determination of the Characteristics of the Nodes of Subsampled Graphs

The machine learning algorithm, such as the encoding-decoding method 300 of example 3, processes, as input data, the characteristics of a plurality of graphs to various scales, obtained by means of the deterministic sampling step 400.

Each input graph comprises a given number of nodes (according to the sampling selected). The input graphs comprise a given number of nodes, which each contain physical characteristics of the fluid flow problem to be solved.

For example, these characteristics can be the coordinates of the center, the normals to the surfaces, the area of the surface, and the conditions at the limits, according to a variant implementation of the simulation method.

During the subsampling as described above, the characteristics of a node of a coarser scale are determined from the characteristics of the nodes of the finer scale.

In order to determine the characteristics of a node corresponding to a group of elements, for example for the group of elements E₀ of the mesh M₁, an integral on all the groups E₁₀ to E₁₃, making up the group of elements E₀, is calculated.

In other words, a characteristic of a node corresponding to a “coarse” group of elements corresponds to the integral of the corresponding characteristics of the groups of elements (or of elements) making it up. In this way, the characteristics are determined in each node while guaranteeing conservation of energy on all the elements of the mesh.

### Other Aspects

The disclosure can be implemented for any type of unstructured data, even non-physical. This also relates to all the data that can be represented by graphs, the concept of geometric element or of a group of elements then corresponding to an initial node or to groups of nodes of the generic problem.

In this case, criteria such as the criterion of subdivision by two for example cannot be defined according to physical characteristics, but can be defined according to characteristics relevant to the problem to be solved, making it possible to define according to which criteria two nodes/groups of nodes of a graph must be grouped together or a group of nodes must be divided.

Even if the concept of spatial coherence during sampling disappears for this type of generic problem, there nevertheless remains coherence by virtue of the implementation of the deterministic sampling step, which is not dictated solely by fast convergence criteria as in the known techniques of the prior art.

Thus the disclosure also relates to a so-called deterministic sampling method configured to process an initial unstructured graph G₀ as an input so as to obtain a set of so-called simulation multiscale graphs, said set of simulation unstructured simulation graphs comprising a number Z≥1 of subsampled unstructured graphs Gᵢ, i∈[1, . . . , Z] , in accordance with the following criteria:
the subsampled graph or graphs Gᵢ each include a number nᵢ of groups of nodes of said initial graph, such that nᵢ being strictly less than N, each nᵢ being distinct;
each subsampled graph Gᵢ being defined over the whole of the space defined by the nodes of the initial graph;
the relationships between the groups of nodes of a subsampled graph Gᵢ and of a subsampled graph Gᵢ₊₁ being stored in an indexing table X_{i,i+1};
the number of subsampled graphs Gᵢ and the number nᵢ of groups of nodes of each subsampled graph Gᵢ being predetermined parameters of said deterministic sampling method.

What is claimed is:

1. Method, implemented by computer, for numerical simulation of a flow of a fluid in a space around a geometry on which an initial mesh M₀ is defined, said initial mesh being divided into a number N of geometric elements, each geometric element being of the surface or volume type, the numerical simulation method being characterized in that it comprises:
a so-called deterministic sampling step configured to process said initial mesh M₀ as an input so as to obtain a set of so-called simulation multiscale meshes, said set of simulation messages comprising a number Z≥1 of subsampled meshes Mᵢ, with i integer between 1 and Z, in accordance with the following criteria:
the subsampled mesh or meshes Mᵢ each include a number nᵢ of groups of geometric elements of said initial mesh, such that nᵢ being strictly less than N, each nᵢ being distinct,
each subsampled mesh Mᵢ being defined over the whole of said space,
the relationships between the groups of geometric elements of a subsampled mesh Mᵢ and of a subsampled mesh Mᵢ₊₁ being stored in an indexing table X_{i,i+1},
the number of subsampled meshes Mᵢ and the number nᵢ of groups of geometric elements of each subsampled mesh Mᵢ being predetermined parameters of said deterministic sampling step;
a step of generating a simulation result from at least one machine learning algorithm of the neural network type, previously trained from a database comprising a plurality of sets of so-called training multiscale meshes each associated with a numerical simulation, to provide a set of simulation data for all or some of the nodes of a mesh Mᵢ in the set of multiscale meshes obtained during the deterministic sampling step.

2. Numerical simulation method according to claim 1, wherein each set of training multiscale meshes comprises a number Z of training meshes M_{1,e} to M_{Z,e} subsampled according to the sampling step from an initial training mesh M_{0,e}.

3. Numerical simulation method according to claim 1, wherein the set of simulation multiscale meshes also comprises the initial mesh M₀.

4. Numerical simulation method according to claim 1, wherein the so-called deterministic sampling step comprises:
a substep of defining a global group of geometric elements, forming a subsampled mesh M₁, said global group corresponding to all the geometric elements of the initial mesh M₀;
at least one substep of dividing at least one group of geometric elements, during which a group of geometric elements of a mesh Mᵢ, comprising nᵢ groups of geometric elements, with i integer between 1 and Z, is divided into a plurality of groups of geometric elements, so as to generate a subsampled mesh Mᵢ₊₁ comprising nᵢ₊₁ groups of geometric elements, with nᵢ₊₁>nᵢ.

5. Numerical simulation method according to claims 1, wherein the so-called deterministic sampling step comprises:
a substep of defining an initial group, during which at least two geometric elements of the initial mesh M₀ are grouped in a group of geometric elements, so as to generate a subsampled mesh M_{Z},
at least one grouping substep, during which at least two groups of geometric elements of a subsampled mesh Mᵢ₊1, comprising nᵢ₊₁ groups of geometric elements, with i integer between 1 and Z−1, are grouped in a group of geometric elements so as to generate a subsampled mesh Mᵢ comprising nᵢ groups of geometric elements, with nᵢ<nᵢ₊₁.

6. Numerical simulation method according to claim 4, wherein the division substep comprises:
an operation of subdivision by two of a group of surface or volume elements of the subsampled mesh Mᵢ, so as to obtain two sets in said group of geometric elements; followed by
one or more operations of subdivision by two of at least one set obtained during a previous subdivision operation,
the sets obtained at the end of the last operation of subdivision by two corresponding to groups of geometric elements of the subsampled mesh Mᵢ₊₁.

7. Numerical simulation method according to claim 6, wherein, in the operation of subdivision by two, the assigning to one or other of the sets is determined using a criterion of physical similarity between two geometric elements.

8. Numerical simulation method according to claim 7, wherein the criterion of physical similarity between two geometric elements is a criterion of spatial proximity in said space.

9. Numerical simulation method according to claim 1, wherein the indexing table is a pair consisting of a subsampling matrix and of a supersampling vector, defining a bijective relationship between the groups of geometric elements of a subsampled mesh Mᵢ and those of a subsampled mesh Mᵢ₊₁.

10. Numerical simulation method according to claim 1, wherein the machine learning algorithm comprises a so-called encoding part and a so-called decoding part;
the so-called encoding part comprising a plurality of subparts for processing by a neural network operating in cascade, the information output from an upstream subpart GNNᵢ₊₁ being subsampled in order to form an input of a downstream subpart GNNᵢ;
the so-called decoding part comprising a plurality of subparts for processing by a neural network operating in cascade, the information output from a downstream subpart GNNᵢ being supersampled in order to form an input of an upstream subpart GNNᵢ₊₁ ;
said subsamplings and said supersamplings between two successive subparts GNNᵢ and GNNᵢ₊₁ being determined by means of said indexing table X_{i,i+1}.

11. Device comprising a processor and a computer storage memory, said memory comprising instructions for configuring the processor to implement the simulation method according to claim 1.
